(19) United States
(12) Patent Application Publication
(10) Pub. No.: US 2008/0191042 A1
(43) Pub. Date: Aug. 14, 2008

(54) Arrangement Provided with a Recording Device

(76) Inventors: Franz Kimmich, Schramberg (DE); Dieter Klostermeier, Villingen-Schwenningen (DE); Horst Nather, Villingen-Schwenningen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/916,219

(22) PCT Filed: Jun. 7, 2006
(86) PCT No.: PCT/EP2006/062969

§ 371 Date: Nov. 30, 2007

(30) Foreign Application Priority Data
Jun. 10, 2005 (DE) 102005026998.2

(51) Int. Cl. G07C 5/10

(52) U.S. Cl. 235/61 V

(57) ABSTRACT

An arrangement (1) has a recording device, in particular a tachograph (2) for a motor vehicle, a voltage source (3) supplying power to the recording device and a sensor (S) transmitting a signal thereto, wherein different modules (7, 8, 9, MEM) of the recording device consume energy and are embodied in such away that they are connectable and disconnectable. In order to solve, in particular, a problem of a relatively unstable voltage supply, the aim of the invention is to design a system whose operation is low-affected by the voltage oscillations and interruptions and which is not overcharged by a just unstable energy supply. For this purpose, several (7, 8, 9, MEM) modules are disconnectable or connectable when the energy supply operating voltage (U) is modified.

### CROSS-REFERENCE TO RELATED APPLICATIONS

This application is a U.S. national stage application of International Application No. PCT/EP2006/062969 filed Jun. 7, 2006, which designates the United States of America, and claims priority to German application number 10 2005 026 998.2 filed Jun. 10, 2005, the contents of which are hereby incorporated by reference in their entirety.

### TECHNICAL FIELD

The invention relates to an arrangement having a recording device, in particular having a tachograph for a motor vehicle, having a voltage source which supplies the recording device with power, having a sensor which transmits a signal to the recording device on the basis of which the recording device stores recordings, wherein various modules of the recording device consume power and are designed so as to be capable of being switched off and on.

### BACKGROUND

Arrangements of the type mentioned at the beginning have already been disclosed in the EEC Regulation 3821/85 recording equipment in road transport. These devices are operated by means of the battery which is provided in the motor vehicle for operating electrical devices. Since the same conditions in terms of stability and fail safety are not satisfied with such a power source as those which a mains connection satisfies, a recording device must have particular measures for voltage fluctuations or a complete failure of the power supply so that previous recordings are not lost or even a defect in the device does not occur at every relatively frequent occurrence of such irregularities. Furthermore, it is desirable that even when there are quite extensive fluctuations of the operating voltage not only previous recordings are retained but also the recording mode is retained for as long as possible. However, in addition to this it is necessary to take into account the fact that the power-supplying vehicle battery is not intended to primarily ensure the function of the recording device but first and foremost has to ensure the function of the motor vehicle. Therefore, in particular in the case in which a battery is becoming exhausted, the recording device, as a power-intensive load, must not burden the weakened power circuit.

### SUMMARY

According to various embodiments, an arrangement of the type mentioned at the beginning can be enhanced in such a way that, on the one hand, voltage fluctuations and interruptions in the power supply adversely affect the operation of the arrangement in the smallest possible degree and, on the other hand, a power supply which is only unstable is not loaded excessively by the arrangement.

According to an embodiment, an arrangement with a recording device may comprise a voltage source which supplies the recording device with power, a sensor which transmits a signal to the recording device on the basis of which the recording device stores recordings, wherein various modules of the recording device consume power and are designed so as to be capable of being switched off and on, and wherein the arrangement is operable in such a way that if there is a change in the operating voltage of the power supply a number of the modules are switched off or on.

According to another embodiment, the various modules may have different energy consumption rates and the modules which are above a specific limiting power consumption can be switched off when there is a drop in the operating voltage. According to another embodiment, specific voltage ranges of the operating voltage can be assigned specific operating modes, modules can be assigned to specific operating modes, and modules which are assigned to the current operating mode S0 can be switched on and modules which are not assigned to the current operating mode can be switched off. According to another embodiment, the voltage ranges which are assigned to specific operating modes can be limited by upper and lower voltage threshold values which each have a different value, in the sense of a hysteresis, for a rising voltage and a dropping voltage, respectively. According to another embodiment, the recording device may have a microcontroller and a system clock as a module, and in a power-saving interactive mode the microcontroller is not active, and during the inactive mode the system clock transmits to the microcontroller, at periodic time intervals, a wakeup command which places the recording device in a power economy pre-mode during which the microcontroller is active. According to another embodiment, when the recording device is in the inactive mode it can be changed from the inactive mode to the power economy pre-mode by a drop in the operating voltage. According to another embodiment, after the operating voltage has been switched on, the recording device may firstly change into the inactive mode. According to another embodiment, the recording device can be connected to an ignition system for a motor vehicle, and after the ignition system is switched off the recording device firstly may check whether the conditions for a change into the inactive mode are met, and it may change into the inactive mode if the conditions are satisfied. According to another embodiment, in the power economy pre-mode the microcontroller may perform tasks which fulfill specific need criteria, and it may go into the inactive mode when the performance of the tasks is concluded. According to another embodiment, the storage of recorded data in an internal memory of the recording device may fulfill the need criteria. According to another embodiment, when the operating voltage drops below a specific voltage threshold value, the recording device may change from a normal operating mode into a rescue mode, at the start of which the individual modules each carry out data protection, and after data protection has been concluded may signal that the data protection is concluded. According to another embodiment, after the data-protecting modules have signaled that the data protection is concluded, the recording device may record the conclusion of the data protection as the time of interruption of the voltage supply and changes into a safety mode. According to another embodiment, the recording device can be a tachograph for a motor vehicle.

### BRIEF DESCRIPTION OF THE DRAWINGS

The invention will be explained in more detail below with reference to drawings and by means of a specific exemplary embodiment for the sake of clarification. In said drawings:

FIG. 1 is a schematic illustration of an arrangement according to an embodiment,

FIG. 2 is a schematic illustration of the software-implemented method of functioning of an arrangement according to an embodiment, and

FIG. 3 is an illustration of the dependence of the operating modes on the operating voltage over time.

### DETAILED DESCRIPTION

According to various embodiments, on the one hand, in the case of a fluctuation in the operating voltage, for example a drop in said voltage below a defined threshold value, modules of the recording device are switched off and in this way the operation of the recording device does not additionally load the unstable power supply. In addition, switching off just some of all the modules of the recording device has the advantage that particularly important functions can be maintained. In this way a recording device according to an embodiment can continue the actual recording function for as long as possible with only low power consumption even if the operating voltage drops. At the same time, in the case of an overvoltage which can frequently be caused by external circumstances in the case of a motor vehicle, some of the modules can be switched off so that at least particularly sensitive components do not suffer a defect. In the case of a drop in the voltage it is expedient to switch off the particularly power-intensive loads among the modules of the recording device, for example a display module of the recording device or a lighting system for a display or operator controlled elements.

In this context, it is appropriate if, among the modules whose power consumption levels respectively differ, the modules which are above a specific limiting power consumption are switched off when there is a drop in the operating voltage. This particularly simple procedure can be provided with exceptions for modules whose operation is indispensable for the particularly important tasks of the recording device, for example the storage or recordings. In particular, it may be expedient if specific voltage ranges of the operating voltage are assigned to specific operating modes and the modules are assigned to specific operating modes so that modules which are assigned to the current operating mode are switched on and modules which are not assigned to the current operating mode are switched off. In this way, the changing of the operating mode occurs as a direct function of the operating voltage with optimization in such a way that when the operating voltage drops below a specific threshold value operating modes which are more economical in terms of power consumption are sequentially activated and when the operating voltage rises operating modes with more intensive power consumption are activated. If the operating voltage rises beyond the normal operating voltage, specific electronic components can be switched off in an overvoltage mode. So that in this context unstable states do not occur due to frequent changing of the operating mode, it is appropriate if the voltage ranges which are assigned to specific operating modes are limited by upper and lower voltage threshold values which each have a different value, in the sense of a hysteresis, for a rising voltage and a dropping voltage, respectively. For example, this can mean that the changeover from the normal operating mode into an overvoltage operating mode when the voltage is rising has a higher voltage threshold value than when the voltage is dropping.

One possible way of switching off modules when there is an operating voltage which is dropping below a specific voltage threshold value is that the recording device switches off a module which is embodied as a microcontroller. The microcontroller may also be one which controls the processes centrally. In this context, it is appropriate if, in addition to the microcontroller, the recording device also has a system clock and during an inactive mode in which the microcontroller is not active, it transmits a wakeup command to the microcontroller at periodic time intervals, which wakeup command places the recording device in a power economy pre-mode. During the power economy pre-mode, the microcontroller changes between brief activity and inactivity. The microcontroller changes from inactivity into activity initiated by a wakeup pulse from a system clock. The system program changes into the power economy pre-mode if specific conditions apply over a specific time period, in particular there is no travel mode of the vehicle and no operator controlled actions take place. On the one hand, it is possible in this way to achieve a considerable saving in power and, on the other hand, it is possible to maintain the essential functions of the recording device with only step-wise activity of the microcontroller. During the phases of the activity of the microcontroller it is appropriate if the latter carries out only tasks which meet specific need criteria or have a correspondingly high priority, and said microcontroller leaves the low-priority tasks unprocessed with the aim of saving power. After the high-priority tasks have been performed, it is appropriate if the microcontroller goes into the inactive mode, provided that the operating voltage is above a specific voltage threshold value. The changeover into the inactive mode can advantageously be dependent on further conditions which include: the ignition system of the motor vehicle is switched off, there is no communication with a test device or diagnostic device on external diagnostic interfaces, there are no incoming pulses from the movement signal transmitter, the voltage supply of the movement signal transmitter is satisfactory, there is no event display (e.g. display of faults), no data card is being processed, conclusion of data recordings (writing/deletion process in a memory), operating voltage is within the specification of the tachograph, the housing of the tachograph is not opened, the tachograph is not in an operating mode for inspection or maintenance, evaluation of activities according to EEC 3821/85 is concluded (for example three minute rule, 120 s rule as per EEC 3821/85), a printout process of an actuated printer is ended or a download process is ended.

If a microcontroller command “Power Down” is issued in the power economy mode, a main loop of this operating mode remains at this point and continues from there after the wakeup command. The power economy mode can be interrupted, that is to say it can be exited either by a hardware reset or an interrupt (fast external interrupt). This interrupt can be expedient: ignition switched on, clock pulse from the system clock, activation of any desired key, opening of the housing, drop in the operating voltage of the sensor, signals from the sensor, drop in the operating voltage of the tachograph.

It is appropriate to change into the power economy pre-mode if the operating voltage is so high that there is no risk of losing unprotected data. When the voltage is excessively low, the microcontroller is preferably to be switched to the active state since the latter can then more precisely determined the time when the operating voltage disappears and can cause this time to be stored. After a restart of the system, this storage can then be a reference point for the operating program to determine whether a fault entry should be made in the memory.

The high-priority tasks of the microcontroller during the power economy pre-mode can advantageously include the storage of recorded data into an internal memory of the recording device. The internal memory can advantageously just buffer this data, in particular if the final storage is to be made via an interface to an external memory and this process were to take a relatively long time.

When the operating voltage drops further below a relatively low specific voltage threshold value it is expedient if the recording device changes from a normal operating mode into a rescue mode, at the start of which the individual modules each carry out data protection and after the conclusion of the data protection signal that the data protection is concluded. The advantage of such feedback lies in the fact that the rescue mode can be initiated without data loss, and the time of the signaling can be defined as the time when the voltage supply is interrupted. The change into the safety mode additionally limits the operation of the recording device so that the power consumption of the recording device is reduced.

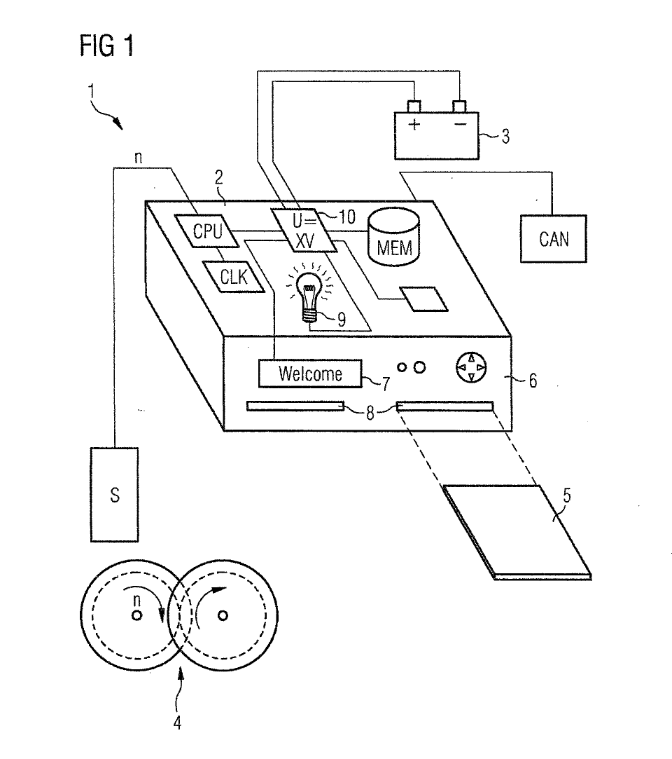

FIG. 1 shows an arrangement 1 having a tachograph 2, a sensor S, a voltage source 3, a controller area network (CAN), a transmission 4 and a data card 5. The tachograph 2 receives signals from the sensor S which converts a rotational speed n of components of the transmission 4 into signal form. A microcontroller MC evaluates the signals of the rotational speed n and transmits them to an internal memory MEM of the tachograph 2.

The tachograph 2 has, on a front side 6, a display module 7, two card holding modules 8 into which data cards 5 can be inserted, a lighting module 9 for lighting the display module 7 and a power supply module 10 and a print module 11. The power supply module 10 connects or interrupts connections between the modules (7, 8, 9, MEM) and the power source 3 by actuating the microcontroller.

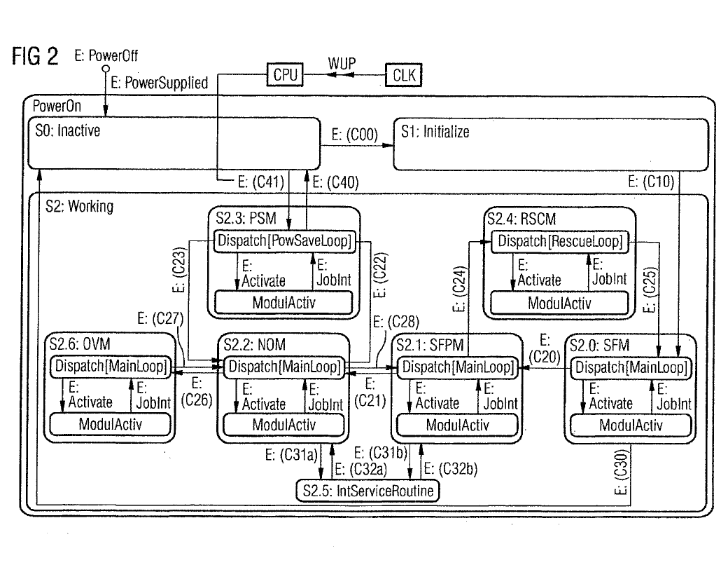

FIG. 2 shows a schematic illustration of the various operating modes S0-S2.6 and the possible changeovers with the conditions (C00)-(C41) or events E which are necessary for them. Starting from an interrupted power supply (E: Power Off), the operating mode changes with the switching on of the tachograph 2 (E: Power Supplied) into an inactive operating mode S0. The inactive operating mode S0 is characterized by the microcontroller MC which is not switched to an active state. If, after the switching on, the operating voltage U exceeds a specific threshold value (E: (C00)), the recording device changes from the operating mode inactive S0 into the initialization mode S1. In this mode, no data recording occurs so that any voltage drop is uncritical. When the initialization is completed (E: (C10)), the recording device changes into a safety mode S2.0 during which the operating voltage can still be in an unsafe range and the operation is consequently restricted, with no data storage taking place. If the operating voltage stabilizes and if it exceeds a specific threshold value the recording device changes into the safety preparation mode S2.1 during which relatively large power loads continue to be switched off but the storage of data already occurs. If the operating voltage U exceeds a further relatively high threshold value, the recording device changes into the normal mode S2.2 in which all the modules of the arrangement adopt normal operation. If an overvoltage occurs, the recording device changes into the overvoltage mode S2.6 during which, in order to avoid damage, the operation is restricted in such a way that certain components are disconnected from the voltage source 3. In this context, the heavy loads are first and foremost disconnected from the voltage since the power loss in the device otherwise exceeds critical values and damage due to heat could occur.

If, starting from the normal mode S2.2, a voltage drop below a specific voltage threshold value occurs, the recording device changes into the safety preparation mode S2.1 and when the voltage drop is continued it firstly changes into the safety mode S2.0 after a positive feedback relating to the data protection is present, and when there is a further voltage drop a changeover into the inactive mode S0 takes place. Starting from the normal mode S2.2, the device goes into the power economy pre-mode S2.3 if all the modules which have been called up signal readiness for this. As soon as this condition of readiness is no longer satisfied, the system changes back into the normal mode S2.2. An essential condition for readiness is data protection. As long as the readiness for the power economy pre-mode is present, the system changes in a chronologically periodic sequence between the inactive mode S0 and the power economy pre-mode S2.3. The change from the inactive mode S0 into the power economy pre-mode S2.3 occurs here by means of a wakeup command WUP which a system clock CLK transmits on a regular basis to the microcontroller MC and thus requests the latter to change into the power economy pre-mode S2.3.

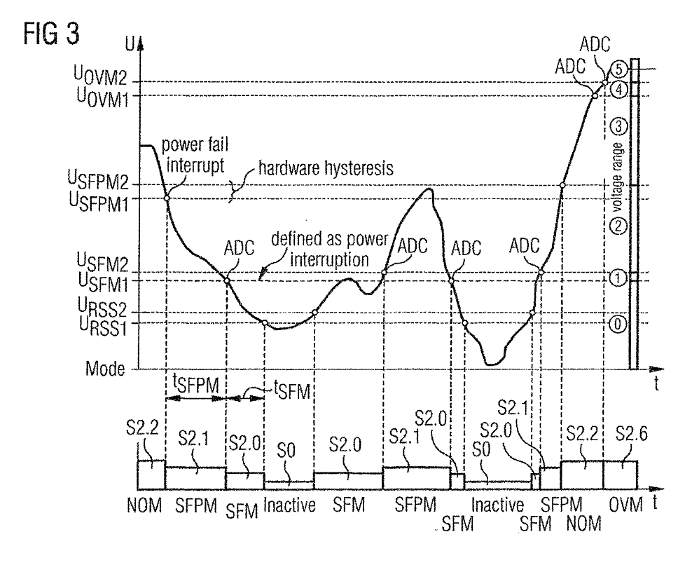

FIG. 3 shows by way of example a voltage profile plotted over time and the changes of the operating modes which are triggered respectively on the basis of the upward or downward transgression of specific voltage threshold values. Starting from the normal mode S2.2, the voltage drops to a first voltage threshold value USFPM1, as a result of which a voltage failure interrupt is triggered at the microcontroller MC. The downward transgression of the voltage threshold value USFPM1 brings about a change into the safety preparation mode S2.1 during which relatively large power loads are switched off and data protection occurs. The progressive drop in voltage to the second voltage threshold value USFM1 results in the recording device going into the safety mode S2.0 in which the operation is restricted and data protection does not occur. When the voltage threshold value URSS1 drops below the operating voltage, the arrangement goes into the inactive mode S0, which brings about deactivation of the microcontroller MC. The following rise in the operating voltage above the voltage threshold value URSS2 causes the recording device to change into the safety mode S2.0 again, in which case the voltage threshold value URSS2 is above the voltage threshold value URSS1, which prevents continuous changing when the operating voltage is in a threshold value range. This behavior can be found during the subsequent rise above and drop below the voltage threshold value USFM1, which does not bring about a change in the operating mode. Only the upward transgression of the operating voltage above a threshold value USFM2 brings about a change into the safety preparation mode S2.1. In the same way, the hysteresis behavior is also apparent in the subsequent section of the recording. The subsequent profile up to the point when the normal mode S2.2 is reached corresponds in principle to the behavior of the recording arrangement which has already been described, in which case it is possible to clearly see that the changing of the operating modes is virtually exclusively dependent on the level of the operating voltage, and the duration of the periods for which the system is in the operating modes is accordingly voltage-controlled. Finally, starting from the normal mode S2.2, the upward transgression of a voltage threshold value UOVM2 causes the arrangement to change into the overvoltage mode S2.6 and specific modules to be disconnected from the voltage supply.

What is claimed is:

1. An arrangement with a recording device comprising:
a voltage source which supplies the recording device with power,
a sensor which transmits a signal to the recording device on the basis of which the recording device stores recordings, wherein various modules of the recording device consume power and are designed so as to be capable of being switched off and on, and wherein the arrangement is operable in such a way that if there is a change in the operating voltage of the power supply a number of the modules are switched off or on.

2. The arrangement according to claim 1, wherein the various modules have different energy consumption rates and the modules which are above a specific limiting power consumption are switched off when there is a drop in the operating voltage.

3. The arrangement according to claim 1, wherein specific voltage ranges of the operating voltage are assigned specific operating modes, modules are assigned to specific operating modes, and modules which are assigned to the current operating mode S0 are switched on and modules which are not assigned to the current operating mode are switched off.

4. The arrangement according to claim 1, wherein the voltage ranges which are assigned to specific operating modes are limited by upper and lower voltage threshold values which each have a different value, in the sense of a hysteresis, for a rising voltage and a dropping voltage, respectively.

5. The arrangement according to claim 1, wherein the recording device has a microcontroller and a system clock as a module, and in a power-saving interactive mode the microcontroller is not active, and during the inactive mode the system clock transmits to the microcontroller, at periodic time intervals, a wakeup command which places the recording device in a power economy pre-mode during which the microcontroller is active.

6. The arrangement according to claim 5, wherein when the recording device is in the inactive mode it is changed from the inactive mode to the power economy pre-mode by a drop in the operating voltage.

7. The arrangement according to claim 5, wherein after the operating voltage has been switched on, the recording device firstly changes into the inactive mode.

8. The arrangement according to claim 5, wherein the recording device is connected to an ignition system for a motor vehicle, and after the ignition system is switched off the recording device firstly checks whether the conditions for a change into the inactive mode are met, and it changes into the inactive mode if the conditions are satisfied.

9. The arrangement according to claim 5, wherein in the power economy pre-mode the microcontroller performs tasks which fulfill specific need criteria, and it goes into the inactive mode when the performance of the tasks is concluded.

10. The arrangement according to claim 9, wherein the storage of recorded data in an internal memory of the recording device fulfills the need criteria.

11. The arrangement according to claim 1, wherein when the operating voltage drops below a specific voltage threshold value, the recording device changes from a normal operating mode into a rescue mode, at the start of which the individual modules each carry out data protection, and after data protection has been concluded signal that the data protection is concluded.

12. The arrangement according to claim 10, wherein after the data-protecting modules have signaled that the data protection is concluded, the recording device records the conclusion of the data protection as the time of interruption of the voltage supply and changes into a safety mode.

13. The arrangement according to claim 1, wherein the recording device is a tachograph for a motor vehicle.

14. A method of operating a recording device comprising a voltage source which supplies the recording device with power, a sensor, and various modules capable of being switched off and on, the method comprising the steps of:
transmitting a signal from the sensor to the recording device on the basis of which the recording device stores recordings,
if there is a change in the operating voltage of the power supply, switching on or off a number of the modules.

15. The method according to claim 14, wherein the various modules have different energy consumption rates and the modules which are above a specific limiting power consumption are switched off when there is a drop in the operating voltage.

16. The method according to claim 14, wherein specific voltage ranges of the operating voltage are assigned specific operating modes, modules are assigned to specific operating modes, and modules which are assigned to the current operating mode S0 are switched on and modules which are not assigned to the current operating mode are switched off.

17. The method according to claim 14, wherein the voltage ranges which are assigned to specific operating modes are limited by upper and lower voltage threshold values which each have a different value, in the sense of a hysteresis, for a rising voltage and a dropping voltage, respectively.

18. The method according to claim 14, wherein the recording device has a microcontroller and a system clock as a module, and in a power-saving interactive mode the microcontroller is not active, and during the inactive mode the system clock transmits to the microcontroller, at periodic time intervals, a wakeup command which places the recording device in a power economy pre-mode during which the microcontroller is active.

19. The method according to claim 18, wherein when the recording device is in the inactive mode it is changed from the inactive mode to the power economy pre-mode by a drop in the operating voltage.

20. The method according to claim 18, wherein after the operating voltage has been switched on, the recording device firstly changes into the inactive mode.

21. The method according to claim 18, wherein the recording device is connected to an ignition system for a motor vehicle, and after the ignition system is switched off the recording device firstly checks whether the conditions for a change into the inactive mode are met, and it changes into the inactive mode if the conditions are satisfied.

22. The method according to claim 18, wherein in the power economy pre-mode the microcontroller performs tasks which fulfill specific need criteria, and it goes into the inactive mode when the performance of the tasks is concluded.

23. The method according to claim 22, wherein the storage of recorded data in an internal memory of the recording device fulfills the need criteria.

24. The method according to claim 14, wherein when the operating voltage drops below a specific voltage threshold value, the recording device changes from a normal operating mode into a rescue mode, at the start of which the individual modules each carry out data protection, and after data protection has been concluded signal that the data protection is concluded.

25. The method according to claim 23, wherein after the data-protecting modules have signaled that the data protection is concluded, the recording device records the conclusion of the data protection as the time of interruption of the voltage supply and changes into a safety mode.
